(19) United States
(12) Patent Application Publication
(10) Pub. No.: US 2014/0180867 A1
(43) Pub. Date: Jun. 26, 2014

(54) SYSTEM AND METHOD FOR CROSS-BORDER LOCATION OF EQUIVALENT GOODS AND SERVICES

(71) Applicant: Matthew Scott Zises, San Jose, CA (US)

(72) Inventor: Matthew Scott Zises, San Jose, CA (US)

(73) Assignee: eBay Inc., San Jose, CA (US)

(21) Appl. No.: 13/724,854

(22) Filed: Dec. 21, 2012

(51) Int. Cl. G06Q 30/06

(52) U.S. Cl. CPC G06Q 30/0631
USPC 705/26.7

(57) ABSTRACT

A system receives a preference of a user, wherein the preference relates to a product or service located in a first geographic location, and then the system receives an identification of a second geographic location. The system analyzes, based on the preference of the user, a database to identify candidate products or services in the second geographic location. The system then determines, from the candidate products or services, an equivalent product or service at least in part by comparison of the candidate products or services to the preference of the user. The system transmits to the user an identification of the equivalent product or service located in the second geographic location.

### TECHNICAL FIELD

The present disclosure generally relates to the cross-border location of equivalent goods and services.

### BACKGROUND

Personal mobile communication devices have become ubiquitous over that last several years. Such devices provide a user with a multitude of services such as basic and upgraded telephone service, global positioning functions, video functions, and Internet access. In particular, the global positioning and Internet access capabilities that are available via personal mobile communication devices have given birth to recommendation applications, wherein when a user is located in a particular geographic location, the user can receive recommendations from businesses and other entities as to products and services located within that geographic location.

### BRIEF DESCRIPTION OF THE DRAWINGS

Some embodiments are illustrated by way of example and not limitation in the figures of the accompanying drawings in which:

FIGS. 1A, 1B, and 1C are a block diagram of an example process and features of the example process for cross-border location of equivalent goods and services.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based system for delivering cross-border recommendations of equivalent products or services.

FIG. 5 is a block diagram illustrating an example cross-border equivalent product or service recommendation sub-system, according to an example embodiment.

FIG. 6 is a diagrammatic representation of a machine in the example form of a computer system within which a set of instructions for causing the machine to perform any one or more of the methodologies discussed herein may be executed.

### DEFINITIONS

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

### DETAILED DESCRIPTION

Example systems and methods for providing cross-border recommendations for products and services are disclosed. In the following description, for purposes of explanation, numerous specific details are set forth in order to provide a thorough understanding of example embodiments. It will be evident, however, to one skilled in the art that the present invention may be practiced without these specific details. It will also be evident that the cross-border location of equivalent goods and services is not limited to the examples provided herein, and may include other scenarios not specifically discussed.

An embodiment of the present disclosure takes the aforementioned recommendation systems to a higher level of intelligence. Specifically, an embodiment permits a person with a personal mobile communication device to locate equivalent goods or services in a geographic location that he or she is visiting (or a geographic location with which he or she is otherwise unfamiliar). In general, the system is knowledgeable of the goods and services that a user prefers in his or her home or normal geographic location, and the system searches several sources to determine what goods or services would be equivalent to those preferred goods or services in a different geographic location, such as a geographic location that that person visits when he or she is on business travel. That is, cross-border refers broadly to a first geographic location wherein a user normally lives and shops, and a second remote geographic location wherein the user does not live and normally does not shop or visit. While there may be actual municipal, state, or country borders involved, that is not a requirement, and cross-border can simply mean two separate geographic areas that may have different identities for similar or equivalent goods or services.

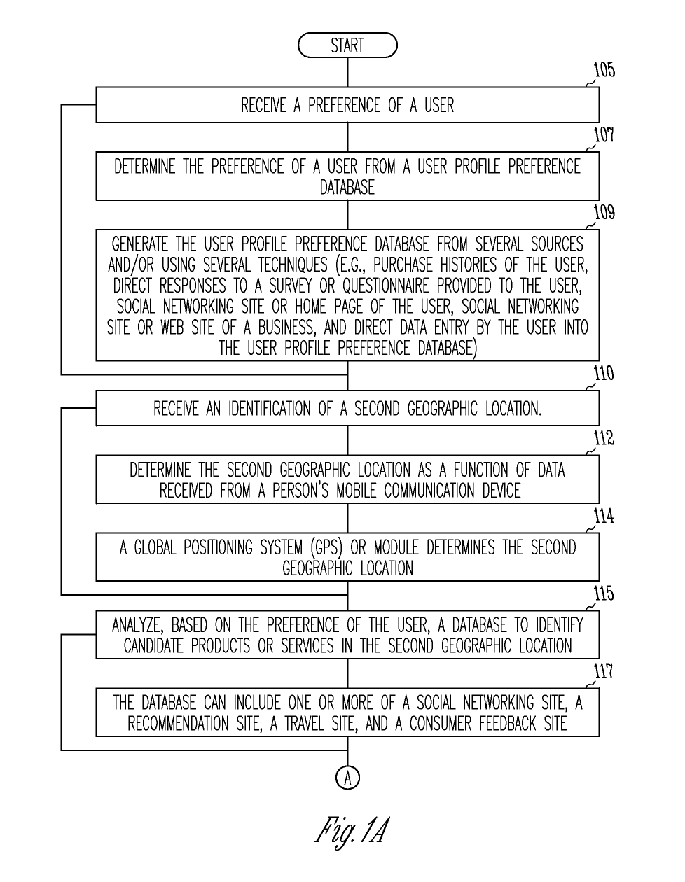

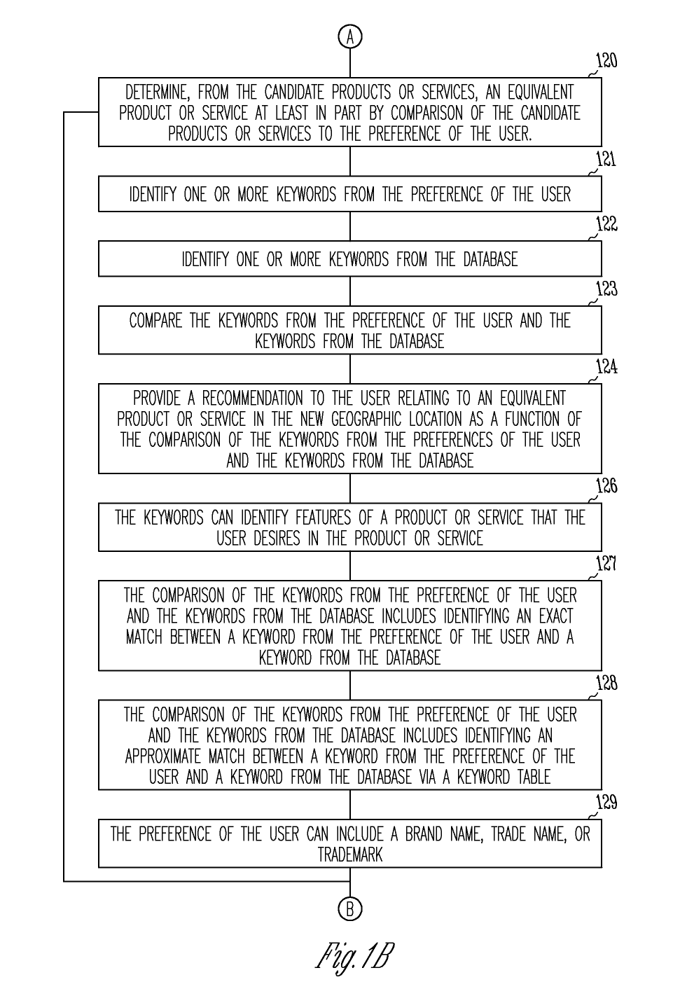

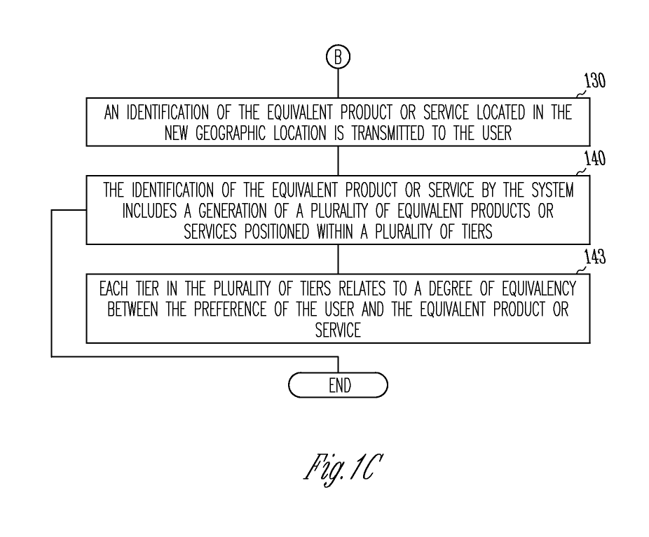

FIGS. 1A, 1B, and 1C are a flowchart-like block diagram of an example process 100 and its features for identifying cross-border equivalents of products and services. FIGS. 1A, 1B, and 1C include a number of process blocks and feature blocks 105-143. Though arranged serially in the example of FIGS. 1A, 1B, and 1C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 1A, 1B, and 1C, at 105, the system receives a preference of a user. The preference relates to a product or service located in a first geographic location. This first geographic location is normally the geographic area in which the user resides and treats as his or her home. As indicated at 107, the preferences of a user can be determined from several sources. In general, such user product and service preferences are normally maintained in a user profile preference database. These user preferences can include many such preferences or likes of the user such as a type of movie (e.g., action and adventure), the type of grocery store (e.g., small and ethnic), the type of restaurant (e.g., Italian), and the type of health facility (e.g., indoor track and pool). Unlike typical user profile preference databases, the user profile preference database in the current system can include one or more reasons why the user likes a particular good, service, or place of business. For example, in the user likes a certain small chain grocery store in his or her home geographic area, the user can indicate the reasons for the liking such as wide aisles, moderate prices, ethnic food sections, and a fresh seafood section.

As illustrated at 109, the user profile preference database can be generated from several sources and/or using several techniques. For example, entries in the user profile preference database can be generated from one or more purchase histories of the user. Such a purchase history can originate from a single merchant, which can indicate both the user's preference for the merchant's goods or services, and/or the goods or services of another source (such as if a user always purchases a particular brand of coffee when shopping at the grocery store). The data in a user profile preference database can also be supplied by direct responses to a survey or questionnaire provided to the user (e.g., What coffee shop do you like and why?). Another source could be the social networking site or home page of the user, wherein the user expresses his or her likes for specific businesses, or the social networking site or web site of a business, wherein a user has indicated his or her fondness for the business or products/services sold/provided by the business. The user can also simply enter data directly into the user profile preference database wherein the user directly indicates his or her product and service preferences.

At 110, the system receives an identification of a second geographic location. As illustrated at 112, the system is operable to determine the second geographic location as a function of data received from a person's mobile communication device. At 114, the system includes a global positioning system (GPS) or module to determine the second geographic location. The ability of the system to identify a current geographic location of a person is a first step in identifying equivalent products in that second geographic location. The system can identify the second geographic location in real time as a user enters the second geographic locations, or in response to a query from the user.

After the system identifies a new geographic location, the system at 115 analyzes, based on the preference of the user, a database to identify candidate products or services in the second geographic location. As indicated at 117, the database can include one or more of a social networking site, a recommendation site, a travel site, and a consumer feedback site (wherein people submit reviews of products and services) to identify the candidate products or services in the new geographic location. For example, the system could analyze databases such as those associated with Yelp, Angie's List, one or more travel sites, Twitter, Facebook, Hunch, and Pinterest. At 120, the system determines, from the candidate products or services, an equivalent product or service at least in part by comparison of the candidate products or services to the preference of the user.

In an embodiment, one or more of the analysis of the database to identify candidate products or services in the second geographic location and the determination, from the candidate products or services, of an equivalent product or service, include several steps. At 121, the system identifies one or more keywords from the preference of the user. At 122, the system identifies one or more keywords from the database. At 123, the system compares the keywords from the preference of the user and the keywords from the database. And at 124, a recommendation is provided to the user relating to an equivalent product or service in the new geographic location as a function of the comparison of the keywords from the preferences of the user and the keywords from the database.

It is worth noting that the analysis and determination processes of the previous paragraph are just one example of an analysis and determination process that could be used in connection with the system and method of the present disclosure. In general, any analysis and determination process could be used. Such an analysis and determination could involve a process wherein a large volume of data is retrieved from a database or other data source. This is in contrast to targeted retrieval of records of known existence, such as the menu of a particular restaurant. Such analyses and determinations to identify equivalent products and services are different than the techniques used in recommendation engines or recommendation sites, which are geared not to the identification of equivalent products or services, but to making recommendations of competitive products and/or encouraging loyal customers to re-patronize a particular business.

As used in the paragraph above, an equivalent product or service does not necessarily mean, although it could, an exact match (i.e., an identical good or service). Rather, it means a substantially similar good or service. In particular, it is a good or service that a user would see as an equivalent or substitute for a tried and tested good or service that the user uses (and likes) on a regular basis. Additionally, it can be based on one or two features of a good or service that a user finds attractive. For example, a user might like a particular local grocery store because it is close to public transportation, has an eastern European food section, and is moderately priced. The user may then consider a grocery store in another geographic location as equivalent to this particular grocery store, even though there are other features of the two grocery stores that are different and thereby do not make them completely or exactly “equivalent.”

Returning to the embodiment of equivalence determination using keywords from the user profile preference and the database, as illustrated at 126, the keywords can identify features of a product or service that the user desires in the product or service. As used in the example above, the keywords may be “eastern European,” “public transportation,” and “moderate price.” As noted above, any grocery store in a new geographic location that is associated with these keywords may be considered equivalent to the user.

At 127, the comparison of the keywords from the preference of the user and the keywords from the database includes identifying an exact match between a keyword from the preference of the user and a keyword from the database. This exact match refers to an exact match of the keywords, such as European matching European, and Germanic and ethic not providing matches for European.

At 128, the comparison of the keywords from the preference of the user and the keywords from the database comprises identifying an approximate match between a keyword from the preference of the user and a keyword from the database via a keyword table. Such a system can provide several matches for a particular keyword. For example, there may be an entry in a keyword table for the term eastern European, and the eastern European entry may have several “equivalents” in the table such as Germanic, ethic, Polish, and Hungarian.

At 129, the preference of the user can include a brand name, trade name, or trademark. In such a case, the identification of the equivalent product or service is based at least in part on matching the brand name, trade name, or trademark with an equivalent product or service that is identified by a different trademark or trade name. For example, if a user likes a particular grocery store in his or her locality, an analysis of a consumer feedback site may indicate that the user's local grocery store or chain and a grocery store or chain in a second geographic location are very similar. The system can then report to the user that the trade name in the second grocery location is equivalent to the grocery store or chain in the user's locale.

At 130, an identification of the equivalent product or service located in the new geographic location is transmitted to the user. The identification of the equivalent product or service can be displayed on the screen of the user's mobile communication device.

At 140, the identification of the equivalent product or service by the system includes a generation of a plurality of equivalent products or services positioned within a plurality of tiers. At 143, each tier in the plurality of tiers relates to a degree of equivalency between the preference of the user and the equivalent product or service. For example, if the user preference profile indicates that a user likes a particular grocery store, and that there are four specific reasons why the user likes the grocery store, then the candidate stores in a second geographic location can be ranked in four tiers based on whether the candidate stores include one, two, three, or all four of the reason why the user likes the particular grocery store.

### Example Operating Environment

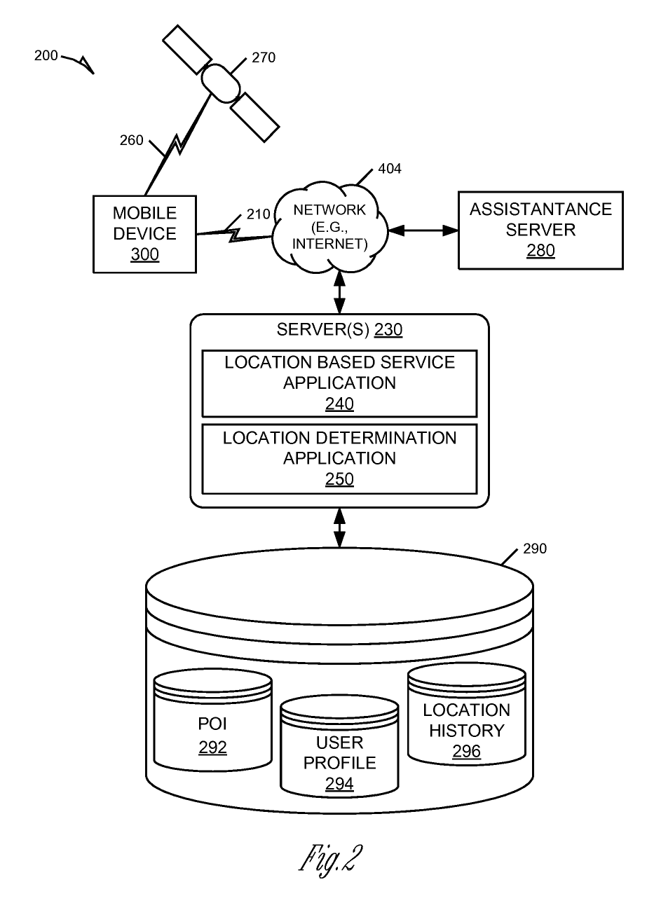

FIG. 2 is a block diagram illustrating an environment 200 for operating a mobile device 300, according to an example embodiment. The mobile electronic device 300 may be any of a variety of types of devices, for example a cellular telephone, a personal digital assistant (PDA), a Personal Navigation Device (PND), a handheld computer, a tablet computer, a notebook computer, or other type of movable device. The device 300 may interface via a connection 210 with a communication network 220. Depending on the form of the mobile electronic device 300, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology. When such technology is employed, the communication network 320 may include a cellular network that has a plurality of cell sites of overlapping geographic coverage, interconnected by cellular telephone exchanges. These cellular telephone exchanges may be coupled to a network backbone, for example, the public switched telephone network (PSTN), a packet-switched data network, or to other types of networks.

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a local area network (LAN), a wide area network (WAN), the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile electronic device 300. For example, one or more servers 230 may execute location based service (LBS) applications 240, which interoperate with software executing on the device 300, to provide LBS's to a user. LBS's can use knowledge of the device's location, and/or the location of other devices, to provide location-specific information, recommendations, notifications, interactive capabilities, and/or other functionality to a user. Knowledge of the device's location, and/or the location of other devices, may be obtained through interoperation of the device 300 with a location determination application 250 executing on one or more of the servers 230. Location information may also be provided by the device 300, without use of a location determination application, such as application 250. In certain examples, the device 300 may have some limited location determination capabilities that are augmented by the location determination application 250. The servers are coupled to database 290, which includes point of interest files 292, user place files 294, and location history files 296.

### Example Mobile Device

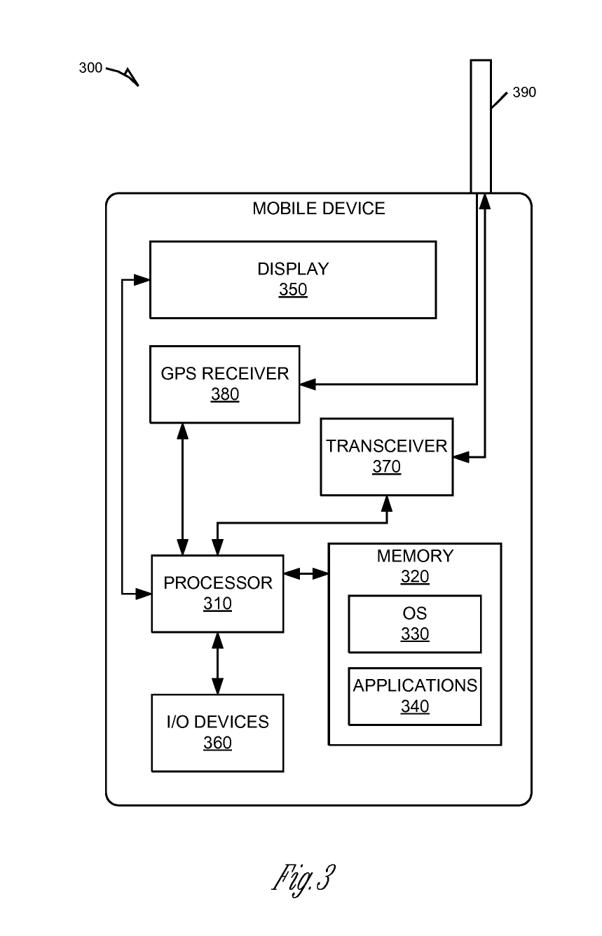

FIG. 3 is a block diagram illustrating the mobile device 300, according to an example embodiment. The device 300 may include a processor 310. The processor 310 may be any of a variety of different types of commercially available processors suitable for mobile devices, for example, an XScale architecture microprocessor, a Microprocessor without Interlocked Pipeline Stages (MIPS) architecture processor, or another type of processor. A memory 320, such as a Random Access Memory (RAM), a Flash memory, or other type of memory, is typically accessible to the processor. The memory 320 may be adapted to store an operating system (OS) 330, as well as application programs 340, such as a mobile location enabled application that may provide LBS's to a user. The processor 310 may be coupled, either directly or via appropriate intermediary hardware, to a display 350 and to one or more input/output (I/O) devices 360, such as a keypad, a touch panel sensor, a microphone, etc. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the device 300. In this manner the connection 310 with the communication network 320 may be established. Further, in some configurations, a GPS receiver 380 may also make use of the antenna 390 to receive GPS signals.

Additional detail regarding providing and receiving location-based services can be found in U.S. Pat. No. 7,848,765, Titled “Location-Based Services,” granted to Phillips et al. and assigned to Where, Inc. of Boston, Mass., which is hereby incorporated by reference.

### Example Platform Architecture

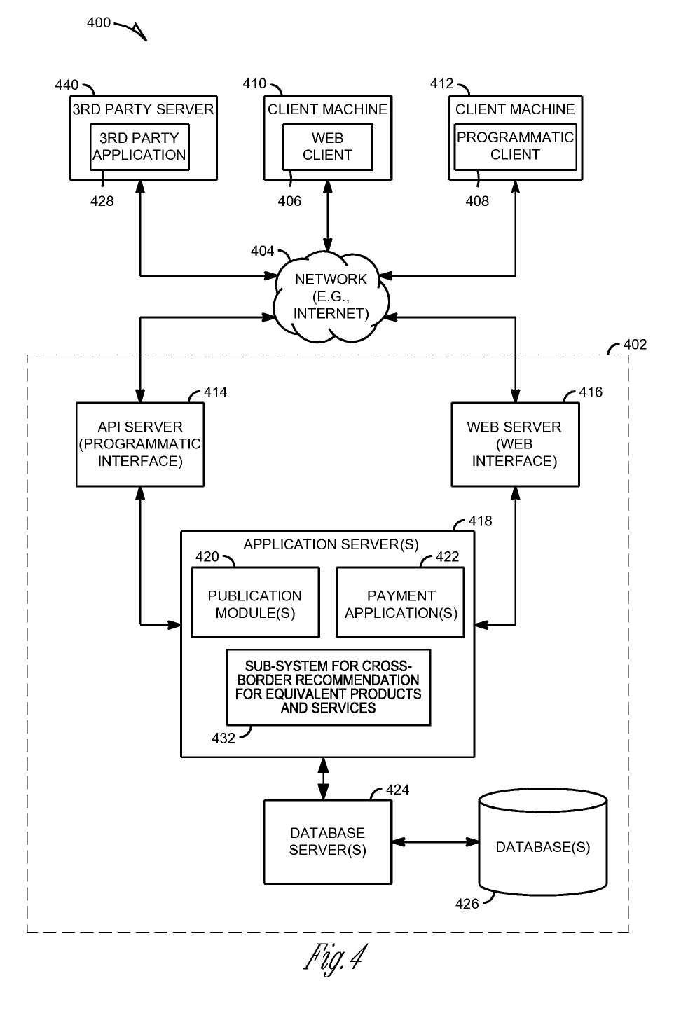

FIG. 4 is a block diagram illustrating a network-based system 400 for delivering cross-border location of equivalent products and services, according to an example embodiment. The block diagram depicting a client-server system 400, within which an example embodiment can be deployed is described. A networked system 402, in the example forms of a network-based location-aware recommendation, advertisement, or publication system, provides server-side functionality, via a network 404 (e.g., the Internet or Wide Area Network (WAN)) to one or more clients 410, 412. FIG. 4 illustrates, for example, a web client 406 (e.g., a browser, such as the Internet Explorer browser developed by Microsoft Corporation of Redmond, Wash. State), and a programmatic client 508 (e.g., WHERE smartphone application from Where, Inc. of Boston, Mass.) executing on respective client machines 410 and 412. In an example, the client machines 410 and 412 can be in the form of a mobile device, such as mobile device 300.

An Application Programming Interface (API) server 414 and a web server 416 are coupled to, and provide programmatic and web interfaces respectively to, one or more application servers 418. The application servers 418 host one or more publication applications 420 (in certain examples these can also include commerce applications, advertising applications, and marketplace applications, to name a few), payment applications 422, and a recommendation sub-system 432. The application servers 418 are, in turn, shown to be coupled to one or more database servers 424 that facilitate access to one or more databases 426. In some examples, the application server 418 can access the databases 426 directly without the need for a database server 424.

The publication applications 420 may provide a number of publication functions and services to users that access the networked system 402. The payment applications 422 may likewise provide a number of payment services and functions to users. The payment applications 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication applications 420. The payment application 422 may also be configured to present equivalent products or services, generated by the cross-border recommendation for equivalent products and services sub-system 432, to a user during checkout (in particular when the user is in a geographic location away from his or her home). The cross-border sub-system 432 may provide real-time equivalent product and service recommendations to users of the networked system 402. The cross-border sub-system 432 can be configured to use all of the various communication mechanisms provided by the networked system 402 to present cross-border equivalent recommendations to users. While the publication applications 420, payment applications 422, and cross-border sub-system 432 are shown in FIG. 4 to all form part of the networked system 402, it will be appreciated that, in alternative embodiments, the payment applications 422 may form part of a payment service that is separate and distinct from the networked system 402.

Further, while the system 400 shown in FIG. 4 employs a client-server architecture, the present invention is of course not limited to such an architecture, and could equally well find application in a distributed, or peer-to-peer, architecture system, for example. The various publication applications 420, payment applications 422, and cross-border sub-system 432 could also be implemented as standalone software programs, which do not necessarily have networking capabilities.

The web client 406 accesses the various publication applications 420, payment applications 422, and cross-border sub-system 432 via the web interface supported by the web server 416. Similarly, the programmatic client 408 accesses the various services and functions provided by the publication applications, payment applications, and cross-border sub-system 420, 422 and 432 via the programmatic interface provided by the API server 414. The programmatic client 408 may, for example, be a local recommendation smartphone application (e.g., the WHERE application developed by Where, Inc., of Boston, Mass.) to enable users to receive real-time location-aware recommendations on their smartphones leveraging user profile data and current location information provided by the smartphone.

FIG. 4 also illustrates a third party application 428, executing on a third party server machine 430, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide cross-border recommendations for goods or services available in a particular geographic location through the cross-border sub-system 432. Additionally, the application server 418 may access advertisement data via a third party system, such as the third party server 440.

### Example Cross-Border Recommendation Sub-System

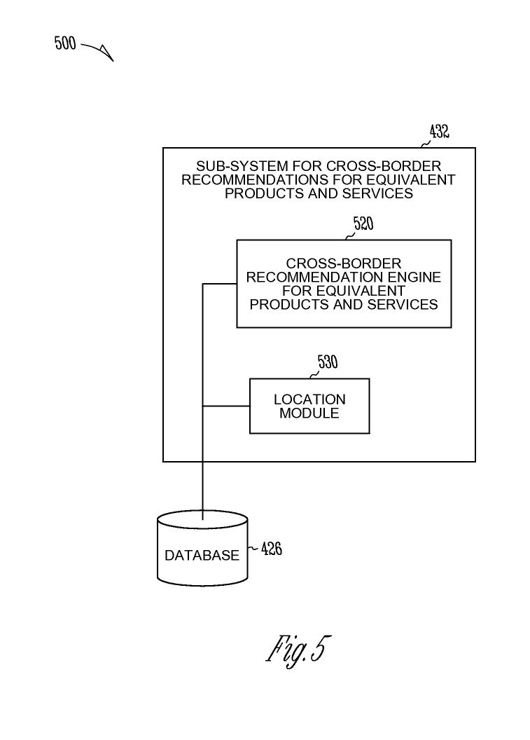

FIG. 5 is a block diagram illustrating an example cross-border recommendation sub-system 432 capable of generating recommendations for equivalent products and services, according to an example embodiment. In this example, the cross-border sub-system 432 can include a location module 530 and a cross-border recommendation engine 520. In this example, the cross-border recommendation sub-system 432 can access database 426 to store and/or retrieve user profile data (e.g., user profile preference data), information about equivalent products and services (e.g., a social networking site, a recommendation site, a travel site, and a consumer feedback site), as well as information about local and remote geographic places (also referred to as location data). As noted above, the cross-border sub-system 432 takes recommendation systems to a higher level of intelligence. Specifically, an embodiment permits a person with a personal mobile communication device 300 to locate equivalent goods or services in a geographic location that he or she is visiting (or a geographic location with which he or she is otherwise unfamiliar). In general, the cross-border sub-system 432 is knowledgeable of the goods and services that a user prefers in his or her home or normal geographic location (via the user profile preference portion of the database 426), and the system 432 searches several sources (e.g., a social networking, a recommendation, a travel, and/or a consumer feedback portion of the database 426) to determine what goods or services would be equivalent to those preferred goods or services in a different geographic location, such as a geographic location that that person visits when he or she is on business travel.

Additional details regarding the functionality provided by the Cross-border recommendation sub-system 432 are detailed in reference to FIG. 1.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

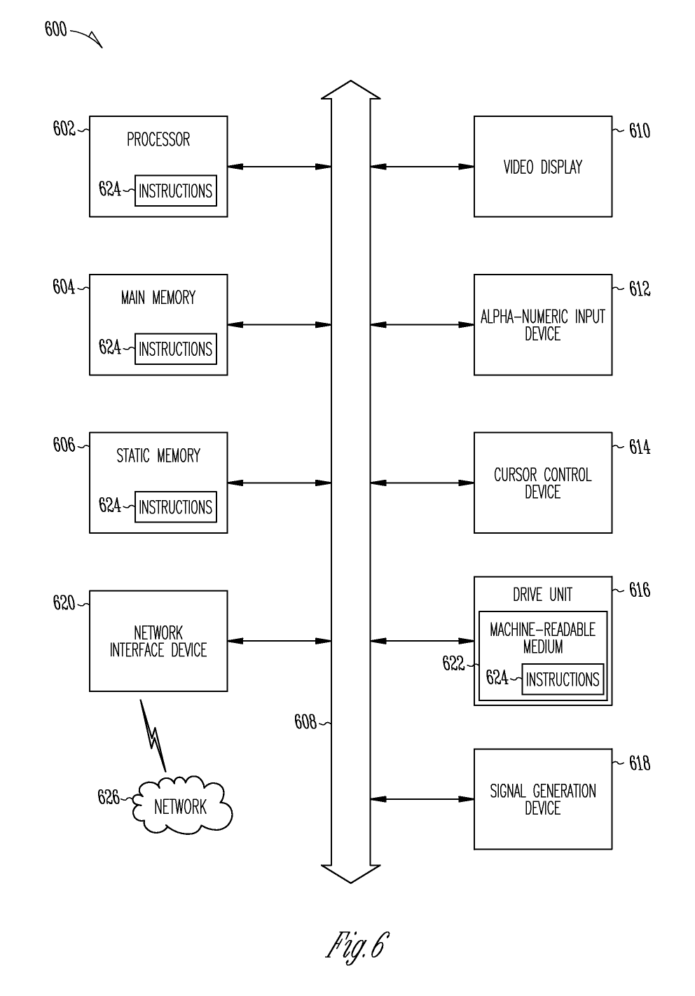

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software) 624 embodying or used by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for cross-border location of equivalent goods and services have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
a computer processor operable to:
receive a preference of a user, the preference relating to a product or service located in a first geographic location;
receive an identification of a second geographic location;
analyze, based on the preference of the user, a database to identify candidate products or services in the second geographic location;
determine, from the candidate products or services, an equivalent product or service at least in part by comparison of the candidate products or services to the preference of the user; and
transmit to the user an identification of the equivalent product or service located in the second geographic location.

2. The system of claim 1, wherein the database comprises one or more of a social networking site, a recommendation site, a travel site, and a consumer feedback site.

3. The system of claim 1, wherein the computer processor is further operable to determine, from data received from a mobile communication device, the second geographic location.

4. The system of claim 3, wherein the computer processor comprises a global positioning system (GPS).

5. The system of claim 1, wherein one or more of the analysis and the determination comprises:
identifying one or more keywords from the preference of the user;
identifying one or more keywords from the database;
comparing the keywords from the preference of the user and the keywords from the database; and
providing a recommendation to the user relating to the equivalent product or service in the second geographic location as a function of the comparison of the keywords from the preference of the user and the keywords from the database.

6. The system of claim 5, wherein the keywords identify features of a product or service that the user desires in the product or service.

7. The system of claim 5, wherein the keywords from the preference of the user comprise a brand name, a trade name, or a trademark, and wherein the identification of the equivalent product or service is based at least in part on matching the brand name, trade name, or trademark with a second brand name, trade name, or trademark.

8. The system of claim 5, wherein the comparing the keywords from the preference of the user and the keywords from the database comprises identifying an exact match between a keyword from the preference of the user and a keyword from the database.

9. The system of claim 5, wherein the comparing the keywords from the preference of the user and the keywords from the database comprises identifying an approximate match between a keyword from the preference of the user and a keyword from the database.

10. The system of claim 1, wherein the computer processor is operable to extract the product preference or service preference of the user from a user profile preference database.

11. The system of claim 10, wherein the user profile preference database is generated from one or more of a purchase history of the user, responses of the user to a survey or questionnaire, a social networking site of the user, or a direct entry by the user of a preference of the user.

12. The system of claim 1, wherein the identification of the equivalent product or service comprises a generation of a plurality of equivalent products or services positioned within a plurality of tiers.

13. The system of claim 12, wherein each tier in the plurality of tiers relates to a degree of equivalency between the preference of the user and the equivalent product or service.

14. A process comprising:
receiving a preference of a user, the preference relating to a product or service located in a first geographic location;
receiving an identification of a second geographic location;
analyzing, based on the preference of the user, a database to identify candidate products or services in the second geographic location;
determining, from the candidate products or services, an equivalent product or service at least in part by comparison of the candidate products or services to the preference of the user; and
transmitting to the user an identification of the equivalent product or service located in the second geographic location.

15. The process of claim 14, wherein the database comprises one or more of a social networking site, a recommendation site, a travel site, and a consumer feedback site.

16. The process of claim 14, comprising:
identifying one or more keywords from the preference of the user;
identifying one or more keywords from the database;
comparing the keywords from the preference of the user and the keywords from the database; and
providing a recommendation to the user relating to the equivalent product or service in the second geographic location as a function of the comparison of the keywords from the preference of the user and the keywords from the database.

17. The process of claim 16, wherein the keywords from the preference of the user comprise a brand name, a trade name, or a trademark, and wherein the identification of the equivalent product or service is based at least in part on matching the brand name, trade name, or trademark with a second brand name, trade name, or trademark.

18. The process of claim 14, comprising extracting the product preference or service preference of the user from a user profile preference database; wherein the user profile preference database is generated from one or more of a purchase history of the user, responses of the user to a survey or questionnaire, a social networking site of the user, or a direct entry by the user of a preference of the user.

19. A computer readable storage device comprising instructions stored thereon that when executed by a processor execute a process comprising:
receiving a preference of a user, the preference relating to a product or service located in a first geographic location;
receiving an identification of a second geographic location;
analyzing, based on the preference of the user, a database to identify candidate products or services in the second geographic location;
determining, from the candidate products or services, an equivalent product or service at least in part by comparison of the candidate products or services to the preference of the user; and
transmitting to the user an identification of the equivalent product or service located in the second geographic location.

20. The computer readable storage device of claim 19, comprising instructions for:
identifying one or more keywords from the preference of the user;
identifying one or more keywords from the database;
comparing the keywords from the preference of the user and the keywords from the database; and
providing a recommendation to the user relating to the equivalent product or service in the second geographic location as a function of the comparison of the keywords from the preference of the user and the keywords from the database.
